(19) United States
(12) Patent Application Publication
(10) Pub. No.: US 2010/0209762 A1
(43) Pub. Date: Aug. 19, 2010

(54) Gravoltaic cell

(76) Inventor: Douglas W. Houle, Clinton Township, MI (US)

Correspondence Address: Gerald R. Black, Esq., Suite 67A, 30320 Southfield Road, Southfield, MI, 48076, US

(21) Appl. No.: 12/658,562

(22) Filed: Feb. 11, 2010

Related U.S. Application Data
(60) Provisional application No. 61/210,133, filed on Mar. 16, 2009.
(60) Provisional application No. 61/207,606, filed on Feb. 17, 2009.

(51) Int. Cl. H01M 6/38; H01M 6/22

(52) U.S. Cl. 429/163; 29/623.1

(57) ABSTRACT

The gravoltaic cell converts a gravitational force into electrical energy. The gravoltaic cell comprises a container, an electrolytic mixture of at least two electrolytes disposed in the container, an upper and lower electrode, and an external electrical load connected across the two said electrodes for dissipating said electrical energy. The electrolytic mixture comprises a denser and a less dense portion. The upper electrode contacts the greater distribution of the less dense electrolytic portion, and the lower electrode contacts the greater distribution of the denser electrolytic portion. A state of electrochemical non-equilibrium exists between the upper and lower electrodes. The electrochemical non-equilibrium has a greater distribution of the less dense portion of the electrolytic mixture near a higher volume of the container, and a greater distribution of the denser portion of the electrolytic mixture near a lower volume of the container. A gravitational field sustains a state of density divergence of a volume of the at least two electrolytes, and the upper and lower volumes of the at least two electrolytes and the upper and lower electrodes are held in stationary position relative to the gravitational field.

This Application is related to and claims priority to U.S. Provisional Application No. 61/207,606, entitled “Electrochemical Baro-Diffusion Cells” filed on Feb. 17, 2009; and U.S. Provisional Application No. 61/210,133, entitled “More Electrochemical Baro-Diffusion Cells” filed on Mar. 16, 2009.

### FIELD OF THE INVENTION

The present invention relates to electrochemical gravoltaic cells, and more particularly, to devices and methods for producing robust and long-lived electrochemical gravoltaic cells that convert a gravitational force into electrical energy.

### BACKGROUND OF THE INVENTION

John Daniell searched for a way to eliminate the hydrogen bubble problem found in the Voltaic Pile. His solution was to use a second electrolyte to consume the hydrogen produced by the first. He invented the Daniell cell in 1836, which consisted of a copper pot filled with a copper sulphate solution, in which was immersed an unglazed earthenware container filled with sulphuric acid and a zinc electrode. The earthenware barrier was porous, which allowed ions to pass through but kept the solutions from mixing. Without this barrier, when no current was drawn the copper ions would drift to the zinc anode and undergo reduction without producing a current, which would destroy the life of the battery.

Over time, copper buildup would block apart the pores in the earthenware barrier and cut short battery life. Nevertheless, the Daniel cell provided a longer and more reliable current than the voltaic cell because the electrolyte deposited copper (a conductor) rather than hydrogen (an insulator) on the cathode. The Daniel cell was also safer and less corrosive. It had an operating voltage of roughly 1.1 volts. The Daniel cell saw widespread use in telegraph networks until it was supplanted by the Leclanché cell in the late 1860s.

In the 1860s, Callaud invented a variant of the Daniell cell which dispensed with the porous barrier. Instead, a layer of zinc sulfate sat on top of a layer of copper sulfate, the two kept separate by their differing densities. The zinc anode was suspended in the top layer while the copper cathode sat in the bottom layer. This gravity cell was less costly for large multicell batteries but could not be moved and was vulnerable to loss of integrity if too much current were drawn, which would cause the layers to mix.

U.S. Pat. No. 39,571 (Hill), entitled “Galvanic Battery” discloses a gravity battery in which:
“. . . the difference in the specific gravity of the two fluids determining the corresponding difference in the positions, the greater specific gravity extending downward towards the lower and the lesser specific gravity the higher local position, thereby dispensing with the porous cup or partition, and at the same time securing greater activity to the galvanic current, . . . ”

Other Gravity Battery Patents:
U.S. Pat. No. 715,654 (Friend), entitled “Gravity Electric Battery”, Dec. 9, 1902;
U.S. Pat. No. 712,668 (Gove), entitled “Gravity Battery”, Nov. 4, 1902;
U.S. Pat. No. 393,203 (Bartley), entitled “Gravity Battery”, Nov. 20, 1888;
U.S. Pat. No. 183,201 (Parrish), entitled “Gravity Battery”, Oct. 10, 1876;
U.S. Pat. No. 142,999 (Edison), entitled “Galvanic Batteries”, Sep. 23, 1873; and
RE 2502 (Hill) entitled “Improvement in Galvanic Batteries”, Re-Issued Mar. 12, 1867.

Gravity batteries derive their energy by converting chemical energy into electrical energy through a chemical reaction. For gravity batteries, the chemical energy converted into electrical energy is arising from the chemical corrosion of a zinc electrode. Energy is consumed in the mining of zinc ore and refining it into pure zinc electrodes and that energy is returned (or released) in the gravity battery by corroding the purified zinc electrode into zinc sulfate, returning the zinc to its original ore state. When the zinc electrode has been consumed, the reaction stops and the electrical energy disappears. The zinc sulfate is then discarded and replaced with a new zinc electrode. The point here is that gravity batteries merely hold the electrolytes in their relative positions.

A “concentration cell” is defined as “a galvanic cell in which the chemical energy converted into electrical energy is arising from the concentration difference of a species at the two electrodes of the cell. An example is a divided cell consisting of two silver electrodes surrounded by silver nitrate solutions of different concentrations. The concentrations of the two solutions will tend to equalize. Consequently, silver cation will be spontaneously reduced to silver metal at the electrode (cathode) in the higher concentration solution, while the silver electrode (anode) in the lower concentration solution will be oxidized to silver cations. Electrons will be flowing through the external circuit [or load] (from the anode or negative electrode to the cathode or positive electrode) producing a current, and nitrate anions will diffuse through the separator. This process will continue till the silver nitrate concentration is equalized in the two compartments of the cell.” (see http://electrochem.cwru.edu/ed/dict.htm#c42—The Case Western Reserve University, Electrochemistry Dictionary).

A number of examples of concentration cells can be found in U.S. patent application Ser. No. 11/366,396, entitled “Solar Driven Concentration Cell” (Bobrik et al.), which states:
The concentration cell typically produces a small voltage, in the order of a few millivolts or hundreds of millivolts. Concentration cells may be combined in series to produce a larger voltage for serving as a power source for driving a load requiring a voltage higher than that produced by a single concentration cell. Concentration cells are useful as a cheap way of producing a small voltage for a short time. When the material used for the two electrodes is the same and the electrolyte used in the two half-cells is the same, differing only in concentration, the concentration cell has the additional advantage that no material is lost, since the metal consumed from the anode electrode is deposited on the cathode electrode. The foregoing description of the concentration cell is well-known in the art.
A problem with using the concentration cell as a source of electrical power is that the voltage produced by the concentration cell, which depends upon the ratio of the electrolyte concentration in the two half-cells (referred to as the concentration gradient), does not remain constant. Rather, when a load is placed across the electrodes or the electrodes are shorted together by a conductor, the cell strives to obtain equilibrium; and the concentration of cations in the cathode half-cell decreases while the concentration of cations in the anode half-cells increases until the two concentrations become equal. Consequently, the voltage produced by the concentration cell steadily decreases until the cell potential becomes zero. If a way can be found to maintain a concentration gradient across the cell, then it becomes more feasible to provide a long term economical source of electrical power with a low cost in materials, since there is no net consumption of materials.
Some efforts have been made to address this problem. U.S. Pat. No. 4,292,378 (Krumpelt, et al.), describes a concentration cell with the two half-cells separated by an ion-exchange member. The electrodes are aluminum and the half-cells contain the same electrolyte-solvent combination in different concentrations. The electrolyte is preferably aluminum chloride (AlCl₃) and the solvent is non-aqueous, preferably ethyl pyridinium chloride, although the salt of an alkali metal may be used. When the concentration gradient of aluminum ions across the two half-cells falls below a predetermined level, the electrolyte solutions are transported from the cell compartments to a distillation column which is operated below 400° C. so that it may be fueled by a solar collector or by industrial waste gases. The higher boiling point solvent is drained from the bottom portion of the column by a pump to a reservoir and eventually returned to the anode half-cell by another pump to dilute the solution and lower the electrolyte concentration. The lower boiling point AlCl₃ electrolyte is removed from the upper portion of the column and pumped to a second reservoir and eventually returned to the cathode half-cell by another pump to raise the aluminum ion concentration in that half-cell. The apparatus in Krumpelt is not adapted for use with electrolytes in aqueous solution, requires expensive external components including pumps and a distillation column, requires a sensor or some form of monitoring before instituting measures to provide for correcting the concentration gradient, and requires temperatures up to 400° C. to operate, rendering the device less suitable for residential or consumer use.
U.S. Pat. No. 4,410,606 (Loutfy et al.) describes a low temperature and thermally regenerative electrochemical system comprising an electrochemical cell having one half-cell containing an aqueous copper (II) sulfate (CuSO₄) solution having two redox couples and a complexing agent, such as acetonitrile, which shifts the redox couple based on the concentration of the complexing agent, and separated by an ion-exchange membrane from a CuSO₄ solution of lower concentration and a source of copper metal in the other half-cell. As the copper ion concentration is decreased in the first cell, a portion of the electrolyte solution is drawn off to a distillation column where the lower boiling point acetonitrile is drawn off for return to the second half-cell, switching the redox couple in the first cell so that copper ion is regenerated.
U.S. Pat. No. 4,037,029 (Anderson) describes a photoelectrogenerative cell with three different variations. In a first embodiment the two half-cells have an electrolyte of equal concentration separated by a membrane permitting ion-exchange, the anolyte half-cell also containing a photosensitive material such as cadmium sulfide, and being irradiated with light. In a second embodiment, the cell comprises a diaphragm separating two half-cells containing equal concentrations of a photochemical electrolyte, such a cuprous chloride, CuCl, the anode being irradiated by light and the cathode being shielded, the electrolyte solutions being protected from oxidation by an oil film. The third embodiment uses photosynthesis to develop a potential difference. The Anderson device differs from the present invention in teaching the use of electrolyte solutions of equal concentration, in the use of a photochemical electrolyte to generate a potential, and in the teaching of an oil film to prevent evaporation and oxidation of the electrolyte. The Anderson device does not address the problem of maintaining a concentration gradient in a concentration cell.
Other devices which illustrate sources of electrical power which utilize some form of energy derived from the sun include U.S. Pat. No. 3,031,520, (Clampitt, et al.) (cell using photochemical reaction of organic isomers); U.S. Pat. No. 3,925,212, (Tchernev) (cell producing electricity by photovoltaic semiconductor devices which decompose water); U.S. Pat. No. 4,262,066, (Brenneman, et al.) (cell which generates electricity using photoreactive organic dye which is regenerated); and U.S. Pat. No. 4,522,695 (Neefe) (device for generating hydrogen fuel which uses photovoltaic semiconductor material disposed in foam on transparent, sloped roof).

Another example of a concentration cell is “Copper(II) Concentration Cell” from the University of Arizona: Chemistry TOPIC: Electrochemistry, hereinafter referred to as “Demo-035”.
“An electrochemical cell is assembled that plates out copper from a concentrated Cu₂₊(aq) solution and dissolves copper from an electrode into a relatively dilute solution of copper ion. The potential that the cell produces can be compared with the voltage predicted by the Nernst equation.”
“This is an interesting electrochemical cell because it is capable of doing electrical work without any net chemical reaction occurring. The number of Cu₂₊ ions and the amount of copper metal in the system does not change; it is the distribution of these substances in the cell that provides the driving force.”
“From the point of view of the second law of thermodynamics, having two solutions of different concentrations in the same container is a highly non-random situation, and the system will attempt to remedy this by diffusing the solutions into each other to form a uniform concentration throughout. Putting copper electrodes into the solutions offers an alternative method of achieving the same end. The upper electrode can release a Cu₂₊ ion into the dilute solution; the electrons so produced then travel through the wires to the other electrode, and a Cu₂₊ ion is removed from the concentrated solution, reduced to a copper atom and plated out on the electrode. (Of course the events of oxidation and reduction really go on simultaneously and the electrons produced by oxidation are not exactly the same ones used up in reduction, but the narrative approach may be a little clearer to students.) The system wants to achieve randomness strongly enough that it will give the electrons sufficient push (the cell potential) that they may be used to do electrical work (but not much: the output is in the microwatt range).”
“The interface between the two solutions is stable for several hours, so the demonstration can be repeated without using any more copper solutions. A certain amount of diffusion of the solutions into each other will not change the cell potential so long as the diffusion does not reach the area of the electrodes.”
“At the end of the demonstration, the solutions can be mixed to show that the cell potential now disappears.”

Demo-035 is not a gravity dependant device since gravity is used only to aid in the formation of the two concentration layers. If the two concentration layers are formed in a zero gravity environment, the higher concentration would still diffuse to the lower concentration to form an equal concentration throughout the entire electrolyte solution. Demo-035 is not a gravity-dependant device, as is the case with the present invention. Additionally, Demo-035 does not use gravity to return the concentrations of matter to their initial states, as is the case in the present invention. Demo-035 demonstrates a concentration difference of a single component “CuSO₄” of a ternary electrolytic mixture comprised of CuSO₄/H₂SO₄/H₂O. The configuration and operation of Demo-035 demonstrates only the effect of a concentration difference of a single component “CuSO₄” of a ternary electrolytic mixture comprised of CuSO₄/H₂SO₄/H₂O. As disclosed, configured and operated, Demo-035 does not take advantage of any unique properties associated with a ternary electrolytic mixture, as does the present invention. Additionally, Demo-035 does not convert gravitational force to electromotive force and does not use gravity to resupply the internal energy of the system drained off as electrical energy by the external electrical load, as is the case with the present invention.

Another example of a concentration cell is U.S. Pat. No. 6,746,788 (Borsuk), “Concentration Cells Utilizing External Fields”, which states: “A method for creating a concentration cell for generating electricity comprising the steps of: providing a first electrode having a first placement and a second electrode having a second placement; and providing a volume of electrolyte that contacts said first electrode and said second electrode and that contains subvolumes which have higher-than-average molarities of a chemical species that is existent within said volume of electrolyte; and providing a field that extends into said volume of electrolyte and that causes said subvolumes to be translationally displaced towards said first electrode; and holding said volume of electrolyte and said first electrode and said second electrode in stationary position relative to said field, so that the translational displacement of said subvolumes increases the molarity of said chemical species near the surface of said first electrode.”

U.S. Pat. No. 6,746,788 (Borsuk), defines the term “translational displacement”:
“As solid 38 dissolves into solution, subvolumes of solution that are localized around the salt attain a temporarily higher solute concentration compared to regions or subvolumes of the solution that are distant from the dissolving salt. The regions or subvolumes containing a temporarily higher solute concentration are subvolumes 22 from FIG. 2. Due to their increased CuSO₄ content, they have a greater mass density than the surrounding solution and will sink towards the surface of electrode 12 due to the field. This sinking or directed translational displacement of subvolumes having a higher than average CuSO₄ concentration is represented by a subvolume 24.” (emphasis added)

And, the term “translationally displaced” as:
“A subvolume 28 represents subvolumes of the solution that have a smaller than average concentration, that rise or are translationally displaced in a direction opposite to that of subvolume 24.” (emphasis added)

All of the above are seen to disclose concentration cells for which one or more of the following are true:
1. They require expensive external components including pumps and a distillation column, require a sensor or some form of monitoring before instituting measures to provide for correcting the concentration gradient, and require temperatures up to 400° C. to operate, rendering the device less suitable for residential or consumer use;
2. They are reconditioned, or regenerated by thermal means and not by gravity;
3. They dissolve solids into solution by thermal means and not by electrochemical oxidizing atoms into solution as liberated cations;
4. They precipitate, reform, or solidify dissolved solids out of solution by thermal means and not by electrochemical reduction of liberated cations out of solution; and
5. They spontaneously diffuse molecules or particles from a high concentration to a lower concentration wherein “the free energy of the diffusion reaction may be used to generate electricity.”

In addition, concentration cells generally have other problems as well:
1. The “ir drop” is defined in The Case Western Reserve University, Electrochemistry Dictionary, as “The electrical potential difference between the two ends of a conducting phase during a current flow. It is the product of the current (i) and the resistance (r) of the conductor. In electrochemistry, it refers to the solution “ir drop”, or to the ohmic loss in an electrochemical cell.” (see http://electrochem.cwru.edu/ed/dict.htm)
A dilute electrolyte has relatively fewer electrically conductively ions than a concentrated electrolyte. A problem with concentration cells is that they suffer from an elevated “ir drop” within the relatively dilute portion of the electrolyte. This dilute electrolyte is a relatively poor electrical conductor (has a relatively high electrical resistance) compared to the more concentrated portion of the electrolyte. This elevated “ir drop” limits the electrical current and electrical power available for an external electrical load. The present invention significantly departs from and improves over the lower “ir drop” of the prior art by novel methods that utilize two relative concentrated electrolytes, one extending to the upper portion of the cell and the other extending to the lower portion of the cell.
2. CONTACT SURFACE AREA: An additional problem with concentration cells is that they suffer from a loss of contact area at the anode/electrolyte interface because the relatively dilute portion of the electrolyte has fewer ions in immediate contact with the surface of the anode than at the cathode. This results in less contact surface area between the electrolyte ions and the anode, which increases the effective electrical resistance at the interface between the anode and the electrolyte. This added electrical resistance limits the electrical current and electrical power available for an external electrical load. The present invention significantly departs from and improves over the loss of contact area of the prior art by novel methods that utilize two relative concentrated electrolytes, one extending to the upper portion of the cell and the other extending to the lower portion of the cell.
3. MOLECULAR COLLISIONS: A further problem with concentration cells is that the electrical energy produced by an electrochemical cell is dependant, in part, on the rate of oxidation reactions at the anode, which in turn, is dependent on the number of molecular collisions between potential producing ions in the electrolyte and the anode atoms at the surface of the anode. The relatively dilute portion of the electrolyte contains relatively fewer potential producing ions in immediate contact with the atoms on the surface of the upper electrode. The fewer potential producing ions in the electrolyte in immediate contact with the atoms on the surface of an electrode, the fewer collisions there are between the potential producing ions in the electrolyte and the atoms on the surface of the electrode, and the less the rate of oxidation reactions at the anode. This decreased rate of oxidation reactions limits the electrical current and electrical power available for an external electrical load. The present invention significantly departs from and improves over the relatively fewer ion/anode collisions of the prior art by novel methods that utilize two relative concentrated electrolytes, one extending to the upper portion of the cell and the other extending to the lower portion of the cell.

The following are definitions and clarifications used throughout this specification for purposes of clarity:

“Gravoltaic” is the field of technology relating to converting gravitational energy directly into electrical energy through electrochemical means. A “gravoltaic cell” is a transducer that converts gravity to electricity, wherein the chemical energy that is converted into electrical energy arises from the struggle between 1) the force of gravity continuously strengthening the electrochemical non-equilibrium at the two electrodes of the cell, and 2) the loading effect of an external electrical load continuously weakening the electrochemical non-equilibrium at the two electrodes of the cell. A “gravoltaic cell” is to gravity as the “photovoltaic cell” is to light. Photovoltaic is the field of technology and research related to the application of solar cells for energy by converting solar energy (sunlight) directly into electrical power. The “photovoltaic cell” is a transducer that converts light to electricity. The “gravoltaic cell” is a transducer that converts gravity to electricity.

“Diverge” means to extend from a common point in different directions.

“Concentrate” means to bring or draw to a common point of union; converge; direct toward one point. “Concentrate” is the opposite of “diverge” and they are two discernable and clearly separate observable phenomenon.

The term “diverged plural-electrolyte” means a gravity-sustained diverged state of electrolyte distribution of two or more electrolytes extending from a common point in opposite directions. The following hypothetical example illustrating a gravity-sustained gradual “diverged plural-electrolyte” distribution of the type utilized by some preferred embodiments of the present invention; in a clear glass container containing a plural-electrolytic mixture comprising a 1:1 ratio of two different electrolytes of different densities, having been prepared by one or the other or a combination of both said variant methods herein cited, at rest in a gravitational field. If the electrolyte having the greater density is blue in color and the electrolyte having the lesser density is red in color, the middle or midlevel of the container would appear violet, indicating equal distribution of each electrolyte. The lower end of the container would appear bluish/violet indicating a greater distribution of the denser electrolytic mixture relative to the distribution of the less dense electrolytic mixture diverged to the lower end of the container. The upper end of the container would appear reddish/violet indicating a greater distribution of the less dense electrolytic mixture relative to the distribution of the denser electrolytic mixture diverged to the higher end of the container. Of course, preferred embodiments of the galvoltaic cell of the present invention may utilize a gradual diverged plural-electrolyte distribution of three or more different electrolytes of three or more different densities in more complex distribution patterns.

The following hypothetical example illustrates a gravity-sustained two layered “diverged plural-electrolyte” of the type utilized by some preferred embodiments of the present invention; in a clear glass container containing a plural-electrolytic mixture comprising a 1:1 ratio of two different electrolytes of different densities. If the electrolyte having the greater density is blue in color and the electrolyte having the lesser density is red in color. The lower end of the container would appear blue indicating the distribution of the denser electrolyte diverged to the lower end of the container. The upper end of the container would appear red indicating the distribution of the less dense electrolyte diverged to the higher end of the container. Of course preferred embodiments of the present invention may utilize a layered diverged plural-electrolyte distribution of three or more layers of three or more different electrolytes of three or more different densities.

The two hypothetical examples cited above are two extremes each at the opposite end of a continuum of possible plural-electrolyte divergences; the gradual diverged plural-electrolyte at one end of the continuum and the layered diverged plural-electrolyte at the other end of the continuum. The term “diverged plural-electrolyte” includes all possible plural-electrolyte divergences along the continuum. The diverged plural-electrolyte is seen by the two electrodes of the cell as an electrochemical non-equilibrium and is referred to herein as an electrochemical non-equilibrium.

A “concentration gradient” is a gradual change in the concentration of solutes in a solution as a function of distance through a solution.

When referring to the gravity-sustained “diverged plural-electrolyte” of the type utilized by the present invention, the term “sustained” is appropriate because gravity does in fact sustain the divergence. When referring to the concentration gradient of the type utilized by the two prior art examples in “Concentration Cells in a Gravitational Field” the term “sustained” is not appropriate because gravity does not in fact sustain the concentration gradient. In the prior art examples, the concentrations equalize throughout the cell and the gradient disappears, as stated in Demo-035 “The interface between the two solutions is stable for several hours, - - - ”, and as stated in U.S. Pat. No. 6,746,788 (Borsuk) “can be thermally reconditioned for repeated generation of electricity by exposing the cells to a cold temperature reservoir. This thermal processing reduces the solubility of the salt in solution, causing the precipitation or reformation of solid 38, thus returning the cells to their original conditions.” For the gravity-sustained gradual “diverged plural-electrolyte,” of the type utilized by the present invention, gravity sustains the divergence and it is gravity (not thermal processing) that returns the cells to their original conditions. The utilization of gravity to sustain the divergence and to return the cells to their original conditions is seen as a significant departure from and an improvement over the prior art.

The following hypothetical example illustrates a gravity-induced concentration gradient of the type utilized by concentration cells. In a clear glass container containing a binary solution of a blue colored solute in a clear solvent, the lower end of the container appears slightly bluer indicating a greater portion of the denser solute at the lower end of the container. The upper end of the container appears less blue indicating a lesser portion of the denser solute at the upper end of the container.

There are many methods of achieving various types of gradients within electrolytic mixtures, the following examples are two methods of achieving concentration gradients:
1. The method of U.S. Pat. No. 6,746,788 (Borsuk), entitled “Concentration Cells Utilizing External Fields”, issued on Jun. 8, 2004, states “and providing a field that extends into said volume of electrolyte and that causes said subvolumes to be translationally displaced towards said first electrode”, and “an external field to move and to collect or aggregate similar types of concentration inhomogeneities that may exist or be caused to exist in subvolumes within electrolytes. Both the movement and aggregation are achieved by utilizing specific differences in the properties of the various chemical components or species that compose the electrolyte. Examples of these properties are mass density, electric moments, and magnetic susceptibility.”
2. The method of “Copper(II) Concentration Cell” from the University of Arizona: Chemistry TOPIC: Electrochemistry, “Demo-035”. “add the 1 M CuSO₄ solution so as to layer it below the 0.01 M CuSO4 solution until the interface between the solutions reaches the mark.”

There are many methods for preparing a gravity-sustained electrochemical non-equilibrium. The following is one of many possible methods for preparing a layered or stair-step gravity-sustained electrochemical non-equilibrium of the type utilized by some preferred embodiments of the present invention. A sample cell container is filled halfway with a mixture of one or more relatively less dense electrolyte(s). A delivery device such as a separatory funnel with some flexible tubing pushed into the exit tube is placed on an iron ring and into the half filled sample cell container so that the tubing just reaches the bottom of the container. A sufficient quantity of a mixture of one or more relatively denser electrolyte(s) is poured into the separatory funnel. The stopcock of the separatory funnel is slowly opened and the one or more relatively denser electrolyte(s) is layered below the one or more relatively less dense electrolyte(s). The separatory funnel and iron ring are then removed.

There are many possible methods for producing a gradual gravity-sustained electrochemical non-equilibrium. The following are two possible methods for preparing a gradual gravity-sustained electrochemical non-equilibrium of the type utilized by the some preferred embodiments of the present invention. 1) A certain amount of initial intermixing occurs when the one or more relatively denser electrolyte(s) is layered below the one or more relatively less dense electrolyte(s). The amount of initial intermixing can be controlled by controlling the rate of flow of the denser electrolytic mixture through the stopcock of the separatory funnel. The greater the flow rate, the greater the flow-induced agitation within the electrolyte volume already in the sample container and the greater the initial intermixing. Thus the amount of the initial intermixing can be controlled to produce an initial electrochemical non-equilibrium at or near the proper working equilibrium. 2) Alternatively, the flow rate can be caused to be slow throughout the entire setup procedure, so that two distinct electrolyte layers are formed. When the proper amount of the constituent electrolytes has been added to the cell, the cell can be left at rest in a gravitational field. Over time, the less dense electrolytic mixture will intermix or diffuse into the denser electrolytic mixture. However, this gravity-induced intermixing will proceed only to a point until the drive for thermodynamic (homogeneity) equilibrium equals gravity's drive for gravitational (divergent) equilibrium.

The electrochemical non-equilibrium, gradual or layered, or at any point along the continuum utilized by various preferred embodiments of the present invention, is a relatively static condition (compared to the dynamic action of net diffusion occurring in concentration cells); it is not the dynamic movement action of electrolytes sinking or rising.

The diverged plural-electrolyte of the type utilized by preferred embodiments of the present invention is double-ended electrolyte distributions because at the lower end of the container there is a greater portion of the denser electrolytic mixture, and at the upper end of the container there is a greater portion of the less dense electrolytic mixture. As opposed to the single electrolyte concentration gradient utilized by concentration cells, which is seen to be single-ended because a greater concentration of the single electrolyte exists only at one end of the container. A double-ended plural-electrolyte divergence is seen to be a significant departure from a single-ended single electrolyte concentration gradient.

For preferred embodiments of the present invention, the chemical energy converted into electrical energy is arising from a gravity-sustained electrochemical non-equilibrium of a plural-electrolytic mixture at the two electrodes of the cell, as opposed to the concentration cell in which the chemical energy converted into electrical energy is arising from the concentration difference of a single electrolyte at the two electrodes of the cell. Deriving energy from a double-ended gravity-sustained plural-electrolyte electrochemical non-equilibrium is seen to be a significant departure from deriving energy from a single-ended single electrolyte concentration difference.

There exists a need for practical and convenient cells for producing robust and long-lived electrochemical cells for generating electrical power and delivering said electrical power to an external workload. Several approaches have been proposed, but none have found commercial acceptance.

### SUMMARY OF THE INVENTION

The gravoltaic cell of the present invention converts a gravitational force into electrical energy. The gravoltaic cell comprises a container, an electrolytic mixture of at least two electrolytes disposed in the container, an upper and lower electrode, and an external electrical load connected across the two said electrodes for dissipating said electrical energy. The electrolytic mixture comprises a denser and a less dense portion. The upper electrode contacts the greater distribution of the less dense electrolytic portion, and the lower electrode contacts the greater distribution of the denser electrolytic portion. A state of electrochemical non-equilibrium exists between the upper and lower electrodes. The electrochemical non-equilibrium has a greater distribution of the less dense portion of the electrolytic mixture near a higher volume of the container, and a greater distribution of the denser portion of the electrolytic mixture near a lower volume of the container. A gravitational field sustains a state of density divergence of a volume of the at least two electrolytes, and the upper and lower volumes of the at least two electrolytes and the upper and lower electrodes are held in stationary position relative to the gravitational field.

Hereafter set forth is a brief overview of the operating principles of the gravoltaic cell of the present invention:
1. Gravity supplies internal mechanical energy to the cell, raising the cell's energy state from a ground state to an exited state.
2. The internal mechanical energy is stored as an electrochemical non-equilibrium within the electrolytic mixture.
3. The internal mechanical energy is converted to electrical energy at the two electrodes of the cell.
4. The cell is unstable at the exited state and seeks stability by transferring said electrical energy to the external electrical load thus lowering the cell's internal energy state from an exited state to a ground state.
5. Whereupon gravity again supplies internal mechanical energy to the cell, again raising the cell's internal energy state from a ground state to an exited state.

Galvoltaic cells of the present invention are a new, unique, non-obvious and useful galvanic cells not previously defined or classified in the art. These galvoltaic cells are galvanic cells in which the chemical energy converted into electrical energy is arising from a gravity-sustained electrochemical non-equilibrium at the two electrodes of the cell. In these galvoltaic cells, there is a natural and continuous striving to equalize the electrochemical non-equilibrium that is counteracted by gravity's continuous striving to sustain the electrochemical non-equilibrium. The galvoltaic cells of the present invention are electrochemical machines designed to exploit the struggle between 1) the force of gravity continuously strengthening the electrochemical non-equilibrium at the two electrodes of the cell, and 2) the loading effect of an external electrical load continuously weakening the electrochemical non-equilibrium at the two electrodes of the gravoltaic cell.

The Operating Method: preferred embodiments of the present invention can be best understood in terms of non-equilibrium thermodynamics, a branch of thermodynamics concerned with systems that are not in thermodynamic equilibrium. Most systems found in nature are not in thermodynamic equilibrium because they are not isolated from their environment and are therefore continuously sharing matter and energy with other systems. This sharing of matter and energy includes being driven by external energy sources as well as dissipating energy. In thermodynamics, a thermodynamic system is said to be in thermodynamic non-equilibrium when it is not in thermal equilibrium, or mechanical equilibrium, or radiative equilibrium, or chemical equilibrium. The present invention relates to systems in chemical non-equilibrium or more specifically systems in electrochemical non-equilibrium. Preferred embodiments of the present invention are both energy driven systems and energy dissipating systems.

For a more complete understanding of the galvoltaic cells of the present invention, reference is made to the following description and accompanying drawings in which the presently preferred embodiment of the invention is shown by way of example. As the invention may be embodied in many forms without departing from the spirit of essential characteristics thereof, it is expressly understood that the drawings are for purposes of illustration and description only, and are not intended as a definition of the limits of the invention.

### BRIEF DESCRIPTION OF THE DRAWINGS

FIG. 1A depicts the first preferred embodiment of the gravoltaic cell of the present invention. The container shown in FIG. 1A contains a gradual diverged electrolytic mixture or electrochemical non-equilibrium of the type used by some of the preferred embodiments of the present invention, wherein a greater distribution of the denser electrolytic mixture relative to the distribution of the less dense electrolytic mixture has been partially diverged to the lower end of the container, and a greater distribution of the less dense electrolytic mixture relative to the distribution of the denser electrolytic mixture has been partially diverged to the higher end of the container. FIG. 1A also depicts the gradual plural-electrolyte divergence end of a continuum of possible plural-electrolyte divergences.

FIG. 1B depicts the container and the electrodes used in the preferred embodiment of the galvoltaic cells of FIG. 1A without the diverged electrolytic mixture.

FIG. 2 depicts the first preferred embodiment of the gravoltaic cell of FIG. 1A. The container represented in FIG. 2 contains a layered diverged electrolyte solution or electrochemical non-equilibrium of the type utilized by some of the preferred embodiments of the present invention, wherein the denser electrolytic mixture has been fully diverged to the lower end of the container, and the less dense electrolytic mixture has been fully diverged to the higher end of the container. FIG. 2 also depicts layered plural-electrolyte divergence end of a continuum of possible plural-electrolyte divergences.

FIG. 3 depicts the second preferred embodiment of a gravoltaic cell of the present invention.

### DETAILED DESCRIPTION OF THE PREFERRED EMBODIMENTS

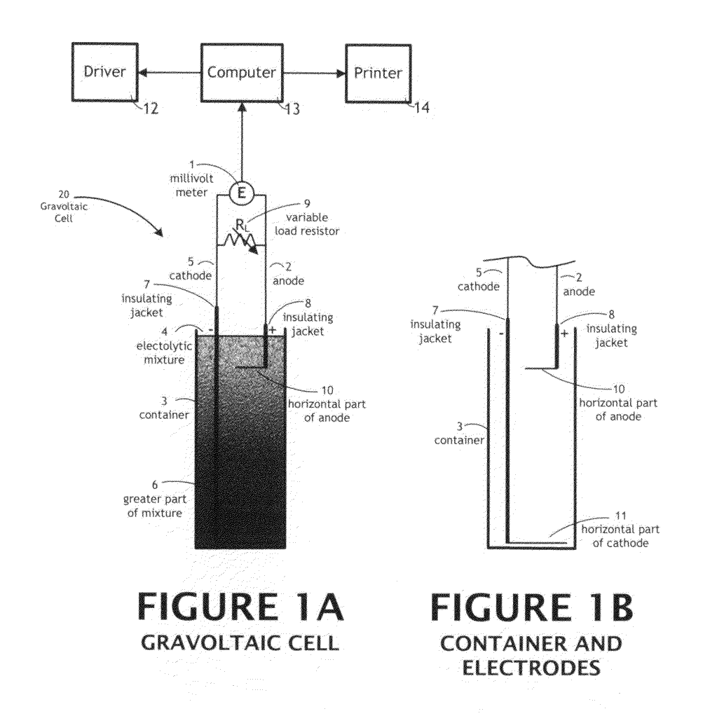

Referring now to FIGS. 1A and 1B, the preferred embodiment of the gravoltaic cell of the present invention 20 comprises: an electrically nonconductive container 3, preferably a glass jar or chemical resistant plastic, containing a gradual gravity-sustained diverged plural-electrolytic mixture in an electrochemical non-equilibrium state, a first electrode 2 immersed in a greater portion of the less dense electrolytic mixture 4 at the upper area of the container 3, a second electrode 5 immersed in a greater portion of the denser electrolytic mixture 6 at the lower area of the container 3. The vertical portions of the electrodes 5 and 2 are insulated from the electrolyte by insulating jackets 7 and 8. The horizontal portions 10 and 11 of the first and second electrodes 2 and 5 are immersed in and exposed to the plural-electrolyte solutions. Additionally, a variable load resistor 9 and a millivoltmeter 1 electrically connected across electrodes 2 and 5. The millivoltmeter 1 is interfaced with the computer 13. Various electrically nonconductive containers such as glass or chemical resistant plastic may be used as the container.

The electrolytic mixture 4 and 6 is a gravity-sustained diverged plural-electrolytic mixture comprised of two or more electrolytes. Said electrolytes are comprised of substances containing free ions that make the substances electrically conductive.

Two identical electrically conductive electrodes 2 and 5 positioned in the electrolyte 4 and 6. The vertical parts of said electrodes insulated from the electrolyte solution by insulating jackets 7 and 8, and means (not shown) to independently rise and lower electrode 2 and electrode 5 within said aqueous plural-electrolyte solution, and means (not shown) to secure and hold electrode 2 and electrode 5 in a stationary position relative to the plural-electrolyte divergence of the plural-electrolyte solutions. The horizontal portion 10 of electrode 2 and the horizontal portion 11 of electrode 5 positioned in and exposed to the aqueous plural-electrolyte solution.

Electrodes are comprised of any electrically conductive material or any combination of electrically conductive materials. The physical composition of electrodes may include but not limited to smooth solid, abraded solid, wool, sponge or nano-particle composition of any electrically conductive material or of any combination of electrically conductive materials. The physical composition of electrodes may include but not limited to any combination of smooth solids, abraded solids, wools, sponges or nano-particles of any electrically conductive material or any combination of electrically conductive materials.

One or more catalytic agent may be used to increase the rate of oxidation and reduction. Some or all said catalytic agents may be part of the anode or the cathode or of both. Some or all said catalytic agents may be part of the less dense electrolyte of the denser electrolyte or of both. Some or all said catalytic agent may be part of the anode/electrolyte interface or the cathode/electrolyte interface or of both.

Millivoltmeter 1 is electrically connected across electrodes 2 and 5 and interfaced with the computer. The variable resistance 9 is set and held at various stationary resistances to assay a number of cell characteristics or can be continuously adjusted to assay other cell characteristics.

A personal computer 13 records and assay the incoming data, and a printer 14 and monitor display connected to the personal computer 13.

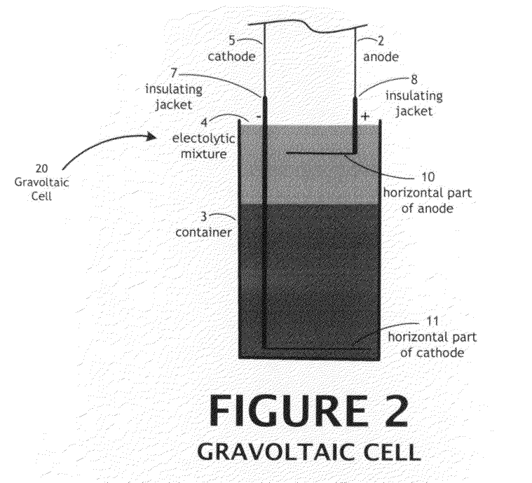

Referring now to FIG. 2, the gravoltaic cell 20 of the present invention is depicted. The container represented in FIG. 2 contains a layered electrolytic mixture 4. The denser electrolytic mixture is fully diverged in the bottom portion of the container 3 and the less dense electrolytic mixture is fully diverged to the upper portion of the container 3.

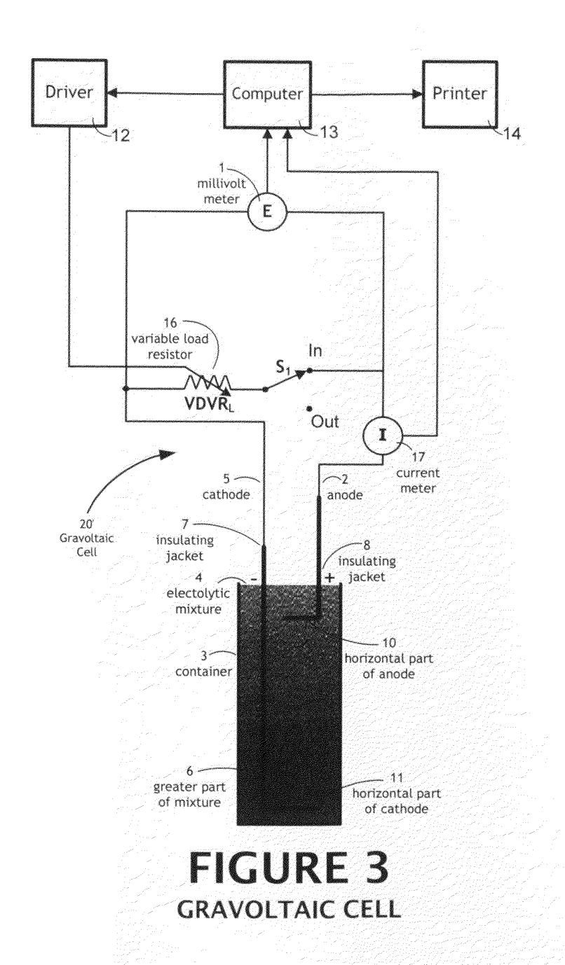

Referring now to FIG. 3, another preferred embodiment of the present invention 20′ is disclosed. The another preferred embodiment present invention 20′ comprises: a container 3, containing a layered gravity-sustained diverged plural-electrolytic mixture in an electrochemical non-equilibrium state, a first electrode 2 immersed in the less dense electrolytic mixture 4 at the upper area of the container 3, a second electrode 5 immersed in the denser electrolytic mixture 6 at the lower area of the container 3. The vertical portions of the electrodes 5 and 2 are insulated from the electrolyte by insulating jackets 7 and 8. Additionally, a voltage dependant variable load resistor ‘VDVR_{L}’ 16 having a resistance controlled by the computer via the driver and load ‘in circuit’/‘out of circuit’ switch S₁, S₁ may also be controlled by the computer; and millivoltmeter 1 electrically connected across electrodes 2 and 5 and interfaced with the computer, and a current meter 17 also interfaced with the computer 13.

The electrolytic mixture 4 and 6 is a gravity-sustained diverged plural-electrolytic mixture comprised of two or more electrolytes. Said electrolytes are comprised of substances containing free ions that make the substances electrically conductive.

Two identical electrically conductive electrodes 2 and 5 positioned in the electrolyte 4 and 6. The vertical parts of said electrodes insulated from the electrolyte solution by insulating jackets 7 and 8, and means (not shown) to independently rise and lower electrode 2 and electrode 5 within said aqueous plural-electrolyte solution, and means (not shown) to secure and hold electrode 2 and electrode 5 in a stationary position relative to the plural-electrolyte divergence of the plural-electrolyte solutions. The horizontal portion 10 of electrode 2 and the horizontal portion 11 of electrode 5 positioned in and exposed to the aqueous plural-electrolyte solution.

Electrodes are comprised of any electrically conductive material or any combination of electrically conductive materials. The physical composition of electrodes may include but not limited to smooth solid, abraded solid, wool, sponge or nano-particle composition of any electrically conductive material or of any combination of electrically conductive materials. The physical composition of electrodes may include but not limited to any combination of smooth solids, abraded solids, wools, sponges or nano-particles of any electrically conductive material or any combination of electrically conductive materials.

One or more catalytic agent may be used to increase the rate of oxidation and reduction. Some or all said catalytic agents may be part of the anode or the cathode or of both. Some or all said catalytic agents may be part of the less dense electrolyte of the denser electrolyte or of both. Some or all said catalytic agent may be part of the anode/electrolyte interface or the cathode/electrolyte interface or of both.

Millivoltmeter 1 is electrically connected across electrodes 2 and 5 and interfaced with the computer, and the current meter 17 is interfaced with the computer 13. The voltage dependant variable load resistor ‘VDVR_{L}’ 9 has a resistance that is controlled by the computer via the driver and load ‘in circuit’/‘out of circuit’ switch S₁. S₁ is deployed for open circuit voltage and loaded circuit voltage assays. The variable resistance of the VDVR_{L} can be set and held at various stationary resistances to assay a number of cell characteristics or can be continuously adjusted to assay other cell characteristics.

A personal computer 13 to record and assay the incoming data and make adjustments via the driver 12 to the voltage dependant variable load resistor, and a printer 14 and monitor display connected to the personal computer 13.

One of the many possible uses of preferred embodiments of the present invention is for detecting the amount of electrical energy produced by sample preferred embodiments comprising the steps of:
A. assaying sample embodiments of the present invention for an elevated level of produced electrical energy; and
B. correlating an elevated level of produced electrical energy of preferred embodiments of the present invention with their relative usefulness as sources of electrical energy.

The present invention is a method for converting gravitational force to useful electrical energy for consumption by an external electrical load comprising the steps of:
A Gravity resupplies internal energy to the electrochemical cell by strengthening the plural-electrolyte divergence, which has been weakened at step “H”, within a plurality of electrolytes, raising the cell's internal energy state from a low energy state to a high energy state, making the cell unstable. Gravitational force is converted to mechanical energy,
B. The plural-electrolyte divergence within a plurality of electrolytes appears as a electrochemical non-equilibrium across a first upper electrode and a second lower electrode of the cell,
C. The cell will tend to move to a state of stability by lowering the internal energy of the cell. The electrochemical non-equilibrium across the two electrodes of the cell will move to a state of equilibrium. The internal energy supplied by gravity is excess energy and which the system tends to rid this excess energy,
D. The electrochemical non-equilibrium across a first upper electrode and a second lower electrode of the cell produces spontaneous oxidation and reduction reactions at said electrodes of the cell. Electrochemical non-equilibrium is converted to electrochemical energy,
E. The spontaneous oxidation and reduction reactions at said electrodes of the cell produces an electromotive force across said electrodes of the cell. Electrochemical energy is converted to electromotive potential energy,
F. The electromotive force pushes electrons through the external electrical load. Electromotive potential energy is converted to electrical kinetic energy (the energy of electrons in motion),
G. The flow of electrons through the external electrical load transfers internal electrical energy from the cell to the external electrical load. Electrical kinetic energy flows to the outside world as this excess internal energy leaves the cell,
H. The transfer of electrical energy from the cell to the external electrical load dissipates the internal energy previously supplied to the cell by gravity, weakening the plural-electrolyte divergence within the plurality of electrolytes which is the same as saying weakening the electrochemical non-equilibrium.
I. Back to step “A”. Gravity resupplies internal energy to the electrochemical cell by strengthening the plural-electrolyte divergence which is the same as saying strengthening the electrochemical non-equilibrium, which has been weakened at step “H”, within a plurality of electrolytes. Gravitational force is converted to mechanical energy,
J. Preferred embodiments of the present invention are continuously driven by one form of energy from the outside world (driven by gravity), while at the same time continuously dissipating another form of energy (electrical energy) back to the outside world.
K. Due to innate inefficiencies and losses, the amount of gravitational energy sustaining the plural-electrolyte divergence within the plurality of electrolytes will always be greater than the electrical energy supplied to the external work load.

The force of gravity supplies the energy needed to sustain a relatively static electrochemical non-equilibrium. The electrochemical non-equilibrium is comprised of a greater distribution of the less dense electrolytic mixture relative to the distribution of the denser electrolytic mixture at the higher end of the container, and a greater distribution of the denser electrolytic mixture relative to the distribution of the less dense electrolytic mixture at the lower end of the container.
A. The electrochemical non-equilibrium may be created by many methods including but not limited to the methods for preparing a layered or stair-step electrochemical non-equilibrium disclosed herein.
B. The gravitational field in which the electrochemical non-equilibrium is sustained, does not cause the spontaneous diffusion of the particles from a high concentration to a lower one, does not causes the electrolytes to move, does not causes some electrolyte(s) to rise towards the upper electrode, and does not causes some electrolyte(s) to sink towards the lower electrode.

An upper electrode contacts the greater distribution of the less dense electrolyte, and a lower electrode contacts the greater distribution of the denser electrolytic mixture. A practice dating back to the 1860's and utilized by gravity batteries.

Due to the gravity-sustained electrochemical non-equilibrium, the electrochemical environment at the upper electrode/electrolyte interface is not equal to the electrochemical environment at the lower electrode/electrolyte interface. The electrochemical environments at the two electrode/electrolyte interfaces are in a state of electrochemical non-equilibrium.

From the point of view of the second law of thermodynamics, this electrochemical non-equilibrium is a highly non-random situation and a state of excess energy that nature will attempt to reduce.

The force of gravity forecloses on the option to diffuse the less dense electrolytic mixture and the denser electrolytic mixture into each other to form an equal distribution of electrolytes throughout the cell.

With an external electrical load connected across the cell's two electrodes, nature is provided with an alternative option and strives to lower the excess internal energy and equalize the two electrochemical environments by spontaneous electrochemical oxidation and reduction reactions. At the anode/electrolyte interface, solid atoms on the surface of the anode will spontaneously oxidize and dissolve into solution as liberated aqueous cations. The external electrical load provides a pathway to equalize the two electrochemical environments.

The electrons produced at the anode by the oxidation reaction will flow from the anode or negative electrode through the external electrical load and return to the cathode or positive electrode, producing an electrical current flow through the external electrical load.

Nature uses electrons returning to the cathode to spontaneously reduce aqueous cations out of solution at the surface of the cathode, and both the oxidation and the reduction reactions to strive to weaken the electrochemical non-equilibrium and the flow of electrons through the external electrical load to reduce the excess energy supplied by gravity.

The flow of electrons through the external electrical load transfers electrical energy from the cell to the external electrical load. This transfer of electrical energy or the loading effect of the external electrical load causes the cell to lose internal energy to the external electrical load. The loose of internal energy weakens the gravity-sustained electrochemical non-equilibrium. However, the force of gravity resupplies the cell with the necessary internal energy needed to sustain the gravity-induced electrochemical non-equilibrium.

The natural striving to equalize of the gravity-sustained electrochemical non-equilibrium is immediately counteracted by gravity striving to strengthen (or resupplying energy to) the electrochemical non-equilibrium and there is no spontaneous diffusion of the particles from a high concentration to a lower one, the electrolytes do not move, electrolytes do not rise towards the upper electrode, and electrolytes do not sink towards the lower electrode.

No net chemical reaction occurs, the number of cations and the amount of electrode material in the system does not change.

The cations produced by oxidation are not exactly the same ones used up in reduction. The electrons produced by oxidation are not exactly the same ones used up in reduction.

The current flow through the external electrical load has an associated “ir drop” or voltage across the two input terminals which is calculated by Ohms law as

V₀=I_{L}·R_{L}

Where “V₀” is the voltage output across the input terminals of the external electrical load,

“I_{L}” is the current supplied by the cell flowing through the external electrical load, and

“R_{L}” is the resistance of the external electrical load.

VOLTAGE OUT: the voltage out “V₀”, of the cell, across the input terminals of the external electrical load is:

V₀=V_{S}·R_{L}/(R_{L}+R_{S})

Where:

R_{S}=V_{S}/I_{L}−R_{L}

Where “V_{S}” is the internal electromotive force of the cell without an external electrical load,

“R_{L}” is the resistance of the external electrical load,

“R_{S}” is the internal resistance of the cell, and

“I_{L}” is the current supplied by the source flowing through the external electrical load.

The V_{S} may be that calculated by the Nernst equation however, for preferred embodiments of the present invention whose electrolyte concentrations or other properties are outside the working parameters of the Nernst equation this may not be so.

Further, the electrical power transferred to the external electrical load by the cell is:

P_{L}=V₀·I_{L}

where P_{L} is the electrical power transferred to an external electrical load from the cell,

Vₒ is the voltage across the input terminals of the external electrical load, and

I_{L} is the current through an external electrical load.

FULL REVERSIBILITY: Fully reversible engines return concentrations of matter to their initial states. Preferred embodiments of the present invention are fully reversible engines because the loading effect of the external electrical load strives to reduce the original state of gravity-induced electrochemical non-equilibrium of the plural-electrolytes, and gravity reverses this by striving to return the gravity-induced electrochemical non-equilibrium back to its original state. This cycle continues as long as the preferred embodiments of the present invention are in a gravitational field. Gravity bringing the electrochemical non-equilibrium back to its original state is seen as significant departure from and an improvement over the prior art.

LONGEVITY: This process will continue over time because gravity provides the energy necessary to sustain the gravity-induced electrochemical non-equilibrium state of the plural-electrolytes at the two electrodes of the cell.

After accounting for the inevitable inefficiencies, as tong as the gravitational energy used to sustain the electrochemical non-equilibrium is sufficiently greater than the electrical energy transferred to the load, the gravity-sustained electrochemical non-equilibrium will remain intact and the electrical energy produced by preferred embodiments of the present invention remains steady; it is gravity continuously sustaining the non-equilibrium in the electrolytes that provides the continuous driving force. The only presently known exception to longevity is electrode passivation.

PASSIVATION: The formation of a thin adherent film or layer on the surface of a metal or mineral that acts as a protective coating to protect the underlying surface from further chemical reaction, such as corrosion, electro-dissolution, or dissolution. The passive film is very often, though not always, an oxide. A passivated surface is often said to be in a “passive state”. The surface oxidation can result from chemical or electrochemical (anodic) oxidation. During anodic passivation, using linear-sweep voltammetry, the current first increases with potential, then falls to a very small value. For preferred embodiments of the present invention, any electrode passivation may result from dissolved oxygen in the electrolytes forming an oxide film or layer on the surface of one or both electrodes.

ELECTRODE MASS: For preferred embodiments of the present invention, the two electrodes each will have their original starting mass, both electrodes may start out with similar masses or one may have a greater mass than the other. In any case, as preferred embodiments of the present invention supplies electrical energy to the load, the anode looses mass due to oxidization of its surface atoms into solution as cations and the cathode gains mass due to reduction of cations to solid atoms plated onto the cathode. At such time as sufficient anode mass has been lost and sufficient cathode mass has been gained, the relative positions of the two electrodes are reversed, so that the former anode becomes the present cathode and the former cathode becomes the present anode. Thus in effect resupplying the anode with mass for further oxidation and freeing the cathode for further reduction. Resupplying the anode with mass for further oxidation is seen as significant departure from and an improvement over the prior art.

The following are two tested and confirmed preferred embodiments of the present invention:

### EXAMPLE 1

an embodiment of the present invention comprising a 250 ml beaker, with an upper copper electrode and a lower copper electrode, filled with a quaternary electrolytic mixture of:
   1. 200 ml, 4.2 molar solution (H₂SO₄₊)
   2. H₂O
   3. 0.5 gm CuSO₄
   4. 0.5 gm MgSO₄
This configuration generated generating a Vₒ of 43 mv., with a load resistance of 10 kΩ, the upper electrode being the anode.

### EXAMPLE 2

However, the upper electrode need not always be the anode. For example, a 250 ml beaker, with an upper copper electrode and a lower copper electrode, filled with a pentenary electrolytic mixture of:
   1. 100 ml 1-molar solution of Al₂(SO₄)₃₊
   2. H₂O
   3. 100 ml 1-molar solution of ZnSO₄, +H₂O
   4. 1 gm CuSO₄
   5. 0.2 gm 4.2 molar solution H₂SO₄
This configuration generated −14 mv when R_{L}=10 mΩ, −10.5 mv when R_{L}=10 kΩ, and −4.6 mv when R_{L}=1 kΩ. The minus signs preceding the voltage values indicate that the anode is the lower electrode. This polarity sign convention is adopted from the 19^{th} century era gravity batteries wherein the upper electrode is the anode or negative electrode. So that all preferred embodiments of the present invention where the anode is the upper electrode is said to have a positive polarity, and all preferred embodiments of the present invention where the anode is the lower electrode is said to have a negative polarity.
The plural-electrolytic mixtures utilized in examples 1 and 2 are specifically designed to exploit the struggle between 1) the force of gravity continuously strengthening the electrochemical non-equilibrium at the electrodes of the cell, and 2) the loading effect of an external electrical load continuously weakening the electrochemical non-equilibrium.

As opposed to concentration cells which single electrolytic mixture is designed to exploit a concentration difference of the single electrolyte at the two electrodes of the cell.

For concentration cells in general and for the concentration cells previously cited, the electrode in contact with the dilute portion of the electrolyte is always the anode and the electrode in contact with the concentrated portion of the electrolyte is always the cathode. More specifically, for both cited “Concentration Cells in a Gravitational Field” the upper electrode is always the anode and the lower electrode is always the cathode. As stated in “Copper(II) Concentration Cell” “The upper electrode can release a Cu₂₊ ion into the dilute solution” in other words for the “Copper(II) Concentration Cell” the upper electrode is always the anode. Further, as stated in U.S. Pat. No. 6,746,788 (Borsuk), “This shows that the polarity of voltage Vₒ is dependent on the orientation of the cell to the field. In the preferred embodiments as represented in FIGS. 3A and 3B, the cathode is always the lower electrode and the anode is always the upper electrode.”

Example 2 above demonstrates that the present invention and preferred embodiments of the present invention significantly departs from and improves over the concentration cell. Specifically, the polarity of voltage Vₒ is dependent on the on the specific electrochemical environments at the two electrodes. This feature offers a wider area for further research and development and greater flexibility of design options over the concentration cell. Example 2 above demonstrates that the underlying phenomena and methods by which the present invention and preferred embodiments of the present invention operate significantly depart from and improve the prior art and is fundamentally different from the prior art.

The present invention discloses a method for converting gravitational force to electromotive force. None of the herein referenced prior art discloses a method for converting gravitational force to electromotive force. The conversion of gravitational force to electromotive force achieved by preferred embodiments of the present invention is seen as a significant departure from and an improvement over the prior art.

Preferred embodiments of the present invention utilize gravity to return the plural-electrolyte divergence or electrochemical non-equilibrium back to its original condition or strength, which is a significant departure from and a significant improvement over the prior art.

The electrodes utilized by preferred embodiments of the present invention are reusable, and the amount of electrode material in the system does not change. At such time as sufficient anode mass has been lost and sufficient cathode mass has been gained, the ability to simply reverse the relative positions of the two electrodes and continue generating electrical energy is seen as a significant departure from and an improvement over the prior art.

By the above reasons and by other reasons disclosed herein, the preferred embodiments of the present invention are seen to be in a separate category apart from the concentration cell.

### CONCLUSIONS

In physics and engineering, energy transformation or energy conversion, is any process of transforming one form of energy to another. Energy of fossil fuels, solar radiation, or nuclear fuels can be converted into other energy forms such as electrical, propulsive, or heating that are more useful to us. Often, machines are used to transform energy. By the herein disclosed methods, preferred embodiments of the present invention are electrochemical machines that convert gravitational energy, energy associated with a gravitational field, to electrical energy.

Throughout this specification, there are various patent/applications that are referenced by application number and inventor. The disclosures of these patents/applications are hereby incorporated by reference in their entireties into this specification in order to more fully describe the state-of-the-art. In order to maintain a reasonable length of disclosure, additional elements using common means known to those skilled in various arts are also incorporated by reference and such means and are not included herein. Any of the preferred embodiments of the gravity and concentration cells disclosed herein may use future means to facilitate disclosed elements, such means not being reasonably anticipated by the inventor at this time, but being herein incorporated by reference.

It is evident that many alternatives, modifications, and variations to the gravoltaic cell of the present invention 20 will be apparent to those skilled in the art in light of the disclosure herein. It is intended that the metes and bounds of the present invention be determined by the appended claim rather than by the language of the above specification, and that all such alternatives, modifications, and variations which form a conjointly cooperative equivalent are intended to be included within the spirit and scope of this claim.

### PARTS LIST

1 millivoltmeter
2 anode electrode
3 container
4 electrolytic mixture
5 cathode electrode
6 greater portion of the denser electrolytic mixture
7 and 8 insulating jackets
9 variable load resistor
10 horizontal portion of electrode 2
11 horizontal portion of electrode 5
12 driver
13 personal computer
14 printer
16 voltage dependant variable load resistor ‘VDVR_{L}’
17 current meter
S₁ load ‘in circuit’/‘out of circuit’ switch
20 1^{st} preferred embodiment of the present invention
20′ 2^{nd} preferred embodiment of the present invention

I claim:

1. A gravoltaic cell for converting a gravitational force into electrical energy, the gravoltaic cell comprising:
a. a container;
b. an electrolytic mixture of at least two electrolytes disposed in said container, said at least two electrolytes having a less dense electrolytic portion and a more dense electrolytic portion;
c. two similar electrodes, an upper electrode that contacts the greater distribution of the less dense electrolytic portion, and a lower electrode that contacts the greater distribution of the more dense electrolytic portion; and
d. an external electrical load connected across the two said electrodes for dissipating said electrical energy; and
wherein a state of electrochemical non-equilibrium exists between said upper and lower electrodes of the gravoltaic cell, said electrochemical non-equilibrium having a greater distribution of the less dense electrolyte portion of the electrolytic mixture near a higher volume of the container, and a greater distribution of the more dense portion of the electrolytic mixture near a lower volume of the container.

2. The gravoltaic cell of claim 1, whereby a gravitational field sustains a state of density divergence of a volume of the at least two electrolytes; and

3. The gravoltaic cell of claim 2, whereby said upper and lower volumes of the at least two electrolytes and said upper and lower electrodes are held in stationary position relative to the gravitational field.

4. A gravoltaic cell for converting a gravitational force into electrical energy, the gravoltaic cell comprising:
a. a container;
b. an electrolytic mixture of at least two electrolytes disposed in said container, said at least two electrolytes having at least one less dense electrolyte and at least one more dense electrolyte;
c. two similar electrodes, an upper electrode that contacts the greater distribution of the at least one less dense electrolyte, and a lower electrode that contacts the greater distribution of the at least one denser electrolyte; and
d. an external electrical load connected across the two said electrodes for dissipating said electrical energy; and
wherein a state of electrochemical non-equilibrium exists between said upper and lower electrodes of the gravoltaic cell, said electrochemical non-equilibrium having a greater distribution of the less dense electrolyte portion of the electrolytic mixture near a higher volume of the container and a greater distribution of the more dense portion of the electrolytic mixture near a lower volume of the container.

5. The gravoltaic cell of claim 4, whereby a gravitational field sustains a state of density divergence of a volume of the at least two electrolytes; and

6. The gravoltaic cell of claim 5, whereby said upper and lower volumes of the at least two electrolytes and said upper and lower electrodes are held in stationary position relative to the gravitational field.

7. A method of creating a gravoltaic cell for converting a gravitational force into electrical energy comprising:
a. providing an electrolytic mixture of at least two electrolytes, said at least two electrolytes comprising at least one less dense electrolyte and at least one more dense electrolyte;
b. providing a gravitational field that sustains a density divergence of a volume of the at least two electrolytes, said divergence of the at least two electrolytes having a common midpoint from which all or part of the at least one less dense electrolyte being sustained at the upper portion of the total volume of the electrolytic mixture and all or part of the at least one more dense electrolyte being sustained at the lower portion of the total volume of the electrolytic mixture;
c. providing two similar electrodes, an upper electrode that contacts the greater distribution of the at least one less dense electrolyte, and a lower electrode that contacts the greater distribution of the at least one denser electrolyte;
d. providing an external electrical load connected across the two said electrodes for dissipating said electrical energy; and
e. holding said volume of at least two electrolytes and said upper and lower electrodes in stationary position relative to said gravitational field.

8. The method of creating a gravoltaic cell of claim 7, wherein the gravitational force converted into electrical energy arises from the struggle between gravitational force continuously strengthening an electrochemical non-equilibrium at said upper and lower electrodes of the gravoltaic cell, and the loading effect of an external electrical load continuously weakening the electrochemical non-equilibrium at said upper and lower electrodes of the gravoltaic cell.

9. The method of creating a gravoltaic cell of claim 7, wherein said continuously strengthening the electrochemical non-equilibrium and said continuously weakening the electrochemical non-equilibrium occur simultaneously and counteract each other so that the amount of electrochemical non-equilibrium of the gravoltaic cell remains at a relatively steady state.

10. The method of creating a gravoltaic cell of claim 7, wherein said continuously strengthening the electrochemical non-equilibrium and said continuously weakening the electrochemical non-equilibrium occur simultaneously and counteract each other so that the amount of electrochemical non-equilibrium of the gravoltaic cell remains at a relatively steady state when compared to the equalization of the amount of electrochemical non-equilibrium during the discharging cycle of the typical non-rechargeable galvanic cell, and during the discharging cycle of the typical rechargeable galvanic cell, additionally when compared to the unequalization of the amount of electrochemical non-equilibrium during the charging cycle of the typical non-rechargeable galvanic cell.

11. A method of creating a gravoltaic cell for converting a gravitational force into electrical energy comprising:
a. providing an electrolytic mixture of at least two electrolytes, said at least two electrolytes comprising at least one less dense electrolyte and at least one more dense electrolyte;
b. providing a gravitational field that sustains a density divergence of a volume of at least two electrolytes, said divergence of the at least two electrolytes having a common midpoint from which all or part of the at least one less dense electrolyte being sustained near the upper volume of the electrolytic mixture, all or part of the at least one more dense electrolyte being sustained near the lower volume of the electrolytic mixture;
c. providing two similar electrodes, an upper electrode that contacts the greater distribution of the at least one less dense diverged electrolyte, and a lower electrode that contacts the greater distribution of the at least one denser electrolyte;
d. providing an external electrical load connected across the two said electrodes for dissipating said electrical energy; and
e. holding said volume of the at least two electrolytes and said upper and lower electrodes in stationary position relative to said gravitational field.

12. The method of creating a gravoltaic cell of claim 11, wherein said gravitational force converted into electrical energy arises from the struggle between gravitational force continuously strengthening an electrochemical non-equilibrium at said upper and lower electrodes of the gravoltaic cell, and the loading effect of an external electrical load continuously weakening the electrochemical non-equilibrium at said upper and lower electrodes of the gravoltaic cell.

13. The method of creating a gravoltaic cell of claim 11, wherein said continuously strengthening the electrochemical non-equilibrium and said continuously weakening the electrochemical non-equilibrium occur simultaneously and counteract each other so that the amount of electrochemical non-equilibrium of the gravoltaic cell remains at a relatively steady state amount of electrochemical non-equilibrium of the gravoltaic cell remains at a relatively steady state when compared to the equalization of the amount of electrochemical non-equilibrium during the discharging cycle of the typical non-rechargeable galvanic cell, and during the discharging cycle of the typical rechargeable galvanic cell, additionally when compared to the unequalization of the amount of electrochemical non-equilibrium during the charging cycle of the typical non-rechargeable galvanic cell.
